(19) United States
(12) Patent Application Publication
(10) Pub. No.: US 2026/0044385 A1
(43) Pub. Date: Feb. 12, 2026

(54) SYTEMS AND METHODS FOR DYNAMIC REVISION AWARENESS AND RESPONSIVE RESOURCE ALLOCATION RECOMENDATIONS

(71) Applicant: Perfectscale Inc., Morrisville, NC (US)

(72) Inventors: Eli Birger, Raleigh, NC (US); Amir Banet, Cary, NC (US); Michael Skylar, Petach-Tikva (IL)

(21) Appl. No.: 19/294,868

(22) Filed: Aug. 8, 2025

Related U.S. Application Data
(60) Provisional application No. 63/680,653, filed on Aug. 8, 2024.

(51) Int. Cl. G06F 9/50; G06F 8/71; G06F 11/30

(52) U.S. Cl. CPC G06F 9/5055; G06F 8/71; G06F 11/302; G06F 2209/508

(57) ABSTRACT

In embodiments, a method includes dynamically detecting a current revision to a software service running within a container and identifying whether the current revision specifies a significant change or not. In response to the identification, the method further includes selecting a time window in which to analyze the service's usage patterns (the “analyzed time window”) and determining whether to include data regarding the service's usage patterns prior to the current revision in the analyzed time window or not. The method further includes recommending a right-sizing implementation for the service based on the usage patterns in the analyzed time window. In embodiments, until data for the entire analyzed time window has been acquired, the method only implements right-sizing recommendations that increase resources available to the service. Once such data has been acquired, the method implements right-sizing recommendations that both increase and decrease such resources.

### CROSS-REFERENCE TO RELATED APPLICATIONS

This application claims the benefit of U.S. Provisional Patent Application No. 63/680,653, filed on Aug. 8, 2024, entitled “Systems and Methods for Resource Allocation,” the entire disclosure of which is hereby incorporated herein by reference.

### TECHNICAL FIELD

The present disclosure relates generally to resource allocation for computerized systems, and more specifically, to systems and methods for dynamic revision awareness and responsive resource allocation recommendations.

### BACKGROUND

Kubernetes is a container orchestration framework that enables running hundreds or thousands of services across a cluster of machines. Each service runs in isolation within containers sharing host resources. To ensure fair scheduling and stable performance, every container must define requests, which are the guaranteed resources (CPU, memory, GPU) reserved for the container, and limits, which are the maximum resources the container may consume, allowing bursts into unallocated capacity while preventing any single container from monopolizing the host.

Incorrect request/limit settings can lead to over-provisioned requests, involving wasted capacity and higher costs when services reserve more than they actually need. Under-provisioned requests can result in resource starvation or unpredictable behavior when services compete for unreserved resources. Under-provisioned limits can cause out-of-memory kills or CPU throttling, causing restarts or degraded performance, whereas over-provisioned limits results in ineffective isolation, allowing “noisy neighbors” to exhaust host resources. Therefore, right-sizing containers is critical for maintaining performance, stability, and cost efficiency.

Conventional right-sizing solutions use a pre-defined static time window on which their recommendations are based. This does not properly reflect the actual situation, and is both inefficient and imprecise.

### SUMMARY OF THE INVENTION

In embodiments, a method includes dynamically detecting a current revision to a software service running within a container and identifying whether the current revision specifies a significant change or not. In response to the identification, the method further includes selecting a time window in which to analyze the service's usage patterns (the “analyzed time window”) and determining whether to include data regarding the service's usage patterns prior to the current revision in the analyzed time window or not. The method further includes recommending a right-sizing implementation for the service based on the usage patterns in the analyzed time window. In embodiments, until data for the entire analyzed time window has been acquired, the method only implements right-sizing recommendations that increase resources available to the service. Once such data has been acquired, the method implements right-sizing recommendations that both increase and decrease such resources.

In embodiments, in response to an identification of the current revision as a significant change, the method further includes only including the service's usage patterns following the current revision in the analyzed time window. The method still further includes setting the analyzed time window to begin at the current revision, and to last N days, where N is a positive real number.

In embodiments, in response to an identification of the current revision as not specifying a significant change to the software service, the method further includes including at least some of the service's usage patterns prior to the current revision in the analyzed time window.

### BRIEF DESCRIPTION OF THE DRAWINGS

Aspects and features of the disclosure will become more apparent in view of the following detailed description when taken in conjunction with the accompanying drawings wherein like reference numerals identify similar or identical elements.

FIG. 1 is a block diagram of an exemplary system for optimizing resource allocation of a computerized system by an orchestration system, in accordance with aspects of the present disclosure.

FIG. 2 is a flow diagram of a method for optimizing resource allocation of a computerized system in accordance with aspects of the disclosure;

FIG. 3 is a flow diagram of exemplary procedures for optimizing resource allocation of a computerized system in accordance with aspects of the disclosure;

FIG. 4 is an illustration exemplifying a process of identification or determination of revisions and operative revisions along a timeline, in accordance with aspects of the disclosure.

FIG. 5 is a flow diagram of another method for optimizing resource allocation of a computerized system in accordance with further aspects of the disclosure;

FIG. 6A is a screen of an exemplary Graphical User Interface (GUI) presenting resource usage of an application of a computerized system, associated with a current revision, and a respective resource allocation recommendation, in accordance with aspects of the present disclosure; and

FIG. 6B is another screen of the exemplary GUI of FIG. 6A presenting an example revision history of the current revision of FIG. 5A, in accordance with aspects of the present disclosure.

FIG. 7 is a process flow diagram for service monitoring, revision type detection, and responsive handling logic, according to an embodiment.

FIG. 8 is an example process flow for dynamically identifying revisions and responsively implementing autoscaler recommendations, according to various embodiments.

### DETAILED DESCRIPTION

The present disclosure relates to various systems and methods for optimizing resource allocation of computerized systems. The disclosed systems and methods ensure peak performance while cutting costs by utilizing data-driven, autonomous actions that continuously optimize resource allocation. Alternatively, or additionally, the disclosed systems and methods ensure peak performance while cutting costs, by considering total financial impact of resource allocation, in particular in view of expected performance improvement.

By tracking usage patterns and configuration trends over time, the disclosed systems and methods provide an actor, a user or a client, e.g., DevOps (Development and Operations) team members, application development team members, and Site Reliability Engineering (SRE) team members, with the necessary data to right-size their application and orchestration system environments and continuously meet demand.

The disclosed resource allocation substantially reduces or even eliminates manual efforts by autonomously keeping cloud costs low and the computerized system environment stable. By continuously calibrating to the computerized system environment's ever-changing demand, configurations, and code releases, autonomous actions of the disclosed systems and methods meet demand in the most cost-effective way.

In the following description, specific details are set forth in order to provide a thorough understanding of the disclosure. However, it is by those skilled in the art that the disclosure may be practiced without these specific details. Further, well-known methods, procedures, and components have not been described in detail so as not to obscure the present disclosure. Some features or elements described with respect to one system may be combined with features or elements described with respect to other systems. For the sake of clarity, discussion of same or similar features or elements may not be repeated.

Although the disclosure is not limited in this regard, discussions utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although the disclosure is not limited in this regard, the terms “plurality” and “a plurality” as used herein may include, for example, “multiple” or “two or more.” The terms “plurality” or “a plurality” may be used throughout the specification to describe two or more components, devices, elements, units, parameters, or the like. Although the disclosure is not limited in this regard, the term “or” is used throughout the specification to include “or”, “and” or both.

The term “application” may refer to and include software or programs having machine-executable instructions which can be executed by one or more processors to perform various operations.

The terms “computerized system”, “computerized environment” or “an environment of a computerized system” may be used interchangeably and may refer to any computerized system including one or more hardware components. The one or more hardware components include one or more hardware processors, e.g., executing software such as applications. Each of the one or more hardware components may be a firm part of the computerized system, installed on the computerized system or located remotely from the computerized system or may be allocated temporarily to the computerized system.

The term “resource utilization of a computerized system” may refer to, according to context, a utilization of computing resources via a Software-based component or via each or a plurality of such Software-based components, included in, executed by, or applied via the computerized system or to a utilization of computing resources by the computerized system or any portion of it or by each or a plurality of such portions. The term “Software-based component”, when used in this context, may include an application, multiple applications, or any other defined unit or piece of Software. The terms “usage” and “utilization” may be used interchangeably.

Unless explicitly stated, the methods described herein are not constrained to a particular order or sequence. Additionally, some of the described methods or elements thereof can occur or be performed simultaneously, at the same point in time, or concurrently.

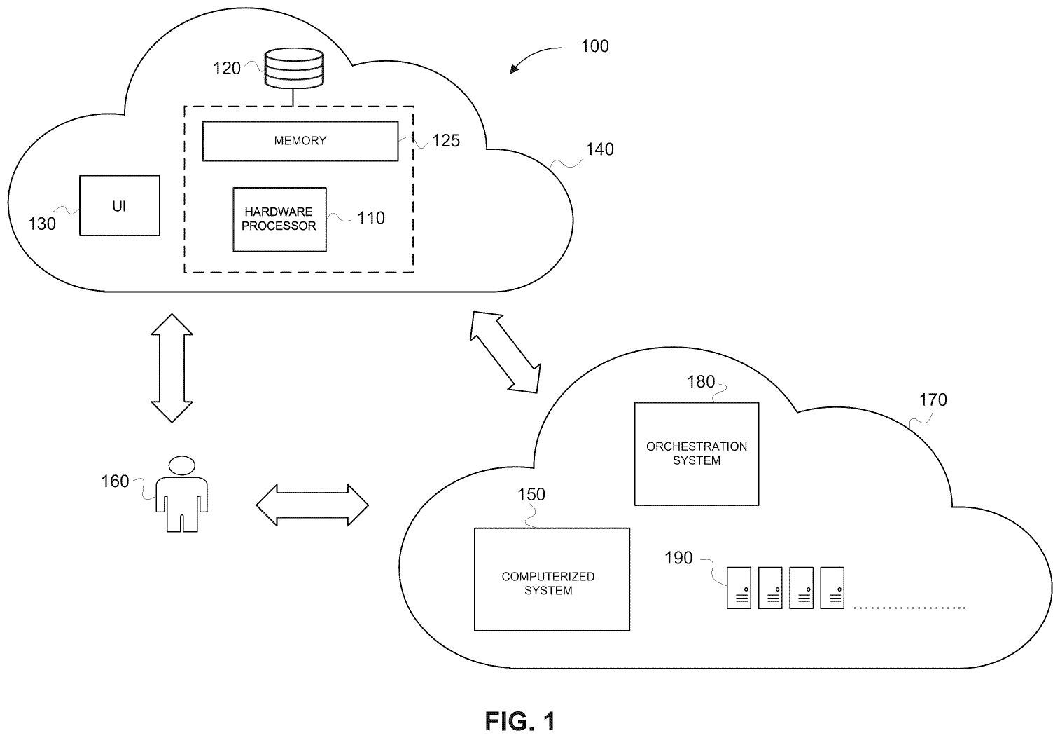

Reference is now made to FIG. 1, which shows a block diagram of an exemplary system 100 for dynamic revision awareness and response for optimizing resource allocation of a computerized system 150 by an orchestration system 180. System 100 may be capable to aggregate customer utilization data, such as utilization data of computerized system 150, store it, and output recommendations or optimization commands.

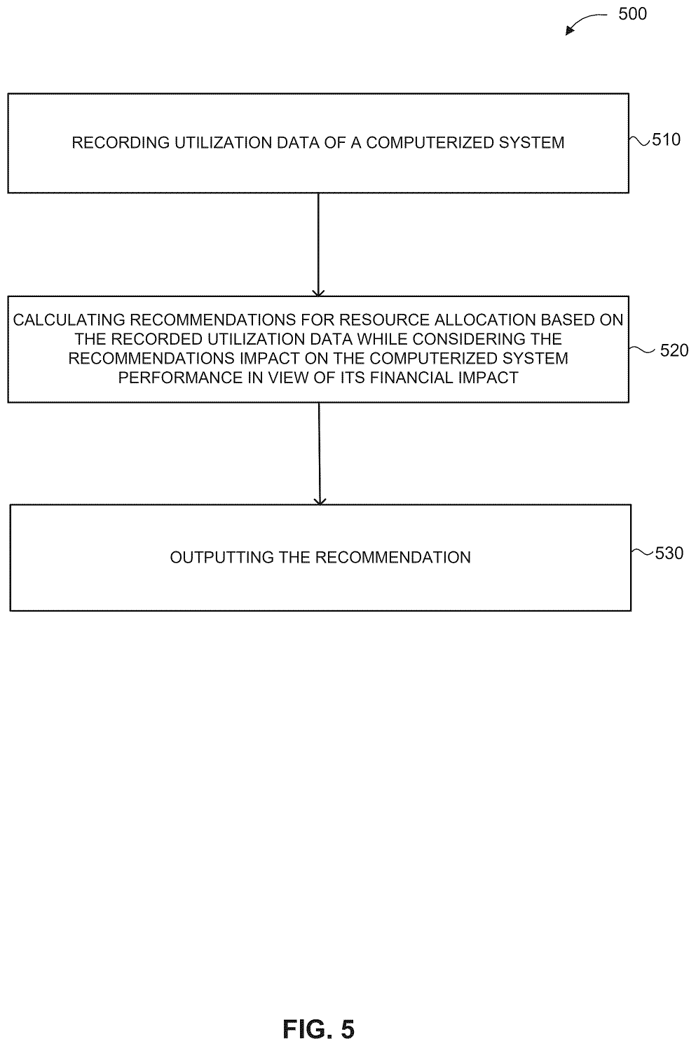

System 100 includes a hardware processor (or controller) 110, a memory device (or memory) 125, a storage device (or storage) 120 and a User Interface 130. System 100 is deployed on a cloud platform 140. However, other configurations may be used. For example, system 100 may be deployed locally, e.g., on a local one or more servers. Storage 120 or memory 125 may include instructions (e.g., one or more applications) for execution by processor 110. According to some aspects, storage device 120 may be used to store data, such as recorded utilization data of computerized system 150. Storage device 120 may be or may include one or more memory devices or one or more storage devices. Memory device 125 may be or may include one or more memory devices. UI 130 may include or may be a GUI, for example, as shown in FIGS. 5A and 5B. The instructions for generating or running UI 130 may be stored in storage 120 or memory 125 and executed by processor 110.

System 100 may communicate with an orchestration system 180. Orchestration system 180 may be in communication with computerized system 150. Operational tasks of computerized system 150 may be automatically orchestrated by orchestration system 180. Orchestration system 180 may be configured, for example, to automate software deployment, scaling, and management of computerized system 150. According to some aspects, orchestration system 180 may be a container orchestration system such as Kubernetes™. Orchestration system 180 may be further in communication with a system providing cloud computing resources, such as storage and processing power, generally illustrated in FIG. 1 as cloud servers 190 (will be also referred to herein as resources 190). According to the layout shown in FIG. 1, computerized system 150, orchestration system 180 and cloud servers 190 are located or run via a cloud platform 170, however, other configurations, layouts or architectures may be used. In some embodiments, e cloud computing resources are provided to computerized system 150 per demand and in return for payment. Cloud platform 170 may be or may include one or more cloud platforms such as, for example, Google Cloud Platform, Amazon Web Services (AWS), or Microsoft Azure. According to some aspects, orchestration system 180 may provide computerized system 150 with resource management services. Accordingly, orchestration system 180 may manage the providing or allocation of resources such as resources 190. According to some aspects, system 100 may apply operations (e.g., automatic resource allocation) to or communicate with computerized system 150 or resources 190 via orchestration system 180. According to some aspects the user (e.g., user 160) or computerized system 150 may employ a Continuous Integration and/or Continuous Delivery and/or Deployment (CICD) system. System 100 may then, alternatively, or additionally, apply operations to or communicate with computerized system 150 or resources 190 via the CICD system.

Computerized system or environment 150 may be any computerized environment which utilizes cloud computing, or which utilizes paid external computing resources. Computerized systems 150 may pertain, for example, to an industry like manufacturing retail, finance, gaming, media, government, healthcare, or agriculture. Computerized system or environment 150 may include one or more computerized systems or environments.

According to some aspects, the disclosed systems and methods may be used with an orchestration system such as system 180 employed by the computerized environment, such as system 150. Alternatively, in some embodiments, the disclosed systems and methods may be used by a computerized environment which does not employ an orchestration system.

According to some aspects, computerized system 150 may include orchestration system 180. According to some aspects, system 100 may include orchestration system 180. According to some aspects, each of clouds 140 and cloud platform 170 may be a public, a private or a hybrid cloud. According to some aspects, one or more of systems 100, 150 and 180 and resources 190 may be deployed on the same cloud platform. According to some aspects, each of systems 100, 150 and 180 may be local systems (e.g., deployed on local servers) and/or cloud-based systems.

A user 160 may include one or more professionals handling computerized system 150 such as, for example, DevOps, application development or SRE teams. User 160 may communicate or interact with system 100 via UI 130. User 160 may further communicate or interact with orchestration system 180.

The computerized system (e.g., system 150 of FIG. 1) can be any system that performs computing and can be configured in various ways, including, without limitation, a cloud system/platform, a shared computing system, a server farm, a proprietary system, a networked Intranet system, a centralized system, or a distributed system, among others, or a combination of such systems.

The disclosed systems may include a processor or controller, such as processor 125 of system 100 of FIG. 1, that may be or may include, for example, one or more central processing unit processor(s) (CPU), one or more Graphics Processing Unit(s) (GPU or GPGPU), and/or other types of hardware processor (or processor), such as a microprocessor, digital signal processor, microcontroller, programmable logic device (PLD), field programmable gate array (FPGA), or any suitable computing or computational device.

The disclosed systems may also include an operating system, a memory, such as memory 125 of system 100 of FIG. 1, a storage, such as storage device 120 of system 100 of FIG. 1, input devices, output devices, or a communication device. The operating system may be or may include any code designed and/or configured to perform tasks involving coordination, scheduling, arbitration, supervising, controlling or otherwise managing operation of computing systems, such as scheduling execution of programs. The memory may be or may include, for example, one or more Random Access Memory (RAM), read-only memory (ROM), flash memory, volatile memory, non-volatile memory, cache memory, and/or other memory devices. The memory may store, for example, executable instructions that carry out an operation (e.g., executable code) and/or data. Executable code may be any executable code, e.g., an app/application, a program, a process, task or script. Executable code may be executed by the controller or processor of the disclosed systems.

The storage may be, or may include, for example, one or more of a hard disk drive, a solid-state drive, an optical disc drive (such as DVD or Blu-Ray), a USB drive or other removable storage device, and/or other types of storage devices. Data such as instructions, code, and procedure data, among other things, may be stored in the storage and may be loaded from the storage into a memory included in the storage where it may be processed by the controller or processor. The input devices may include, for example, a mouse, a keyboard, a touch screen or pad, or another type of input device. The output devices may include one or more monitors, screens, displays, speakers and/or other types of output devices.

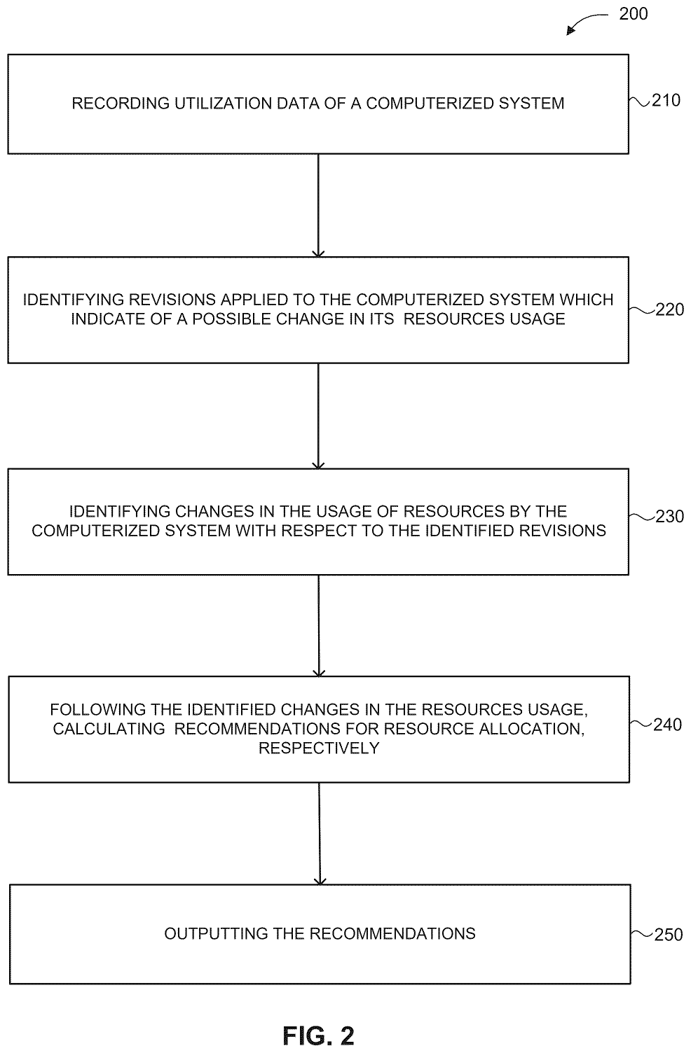

Reference is now made to FIG. 2, which shows a process flow diagram 200 of a method for optimizing resource allocation of a computerized system, e.g., such as computerized system 150 of FIG. 1. Method 200 may be implemented by the disclosed systems such as system 100 of FIG. 1.

At block 210, usage of resources by the computerized system (e.g., computerized system 150 of FIG. 1), which will also be referred to as “utilization data”, may be recorded or monitored. The utilization data may provide information with respect to the extent of resource used (e.g., in Mebibytes (MiB) for memory or millicores for Central Processing Unit (CPU)) per time. According to some aspects, the utilization data may be recorded continuously. According to some aspects the recording may be performed in accordance with one or more preset or selected rules or in accordance with a selected mode of operation.

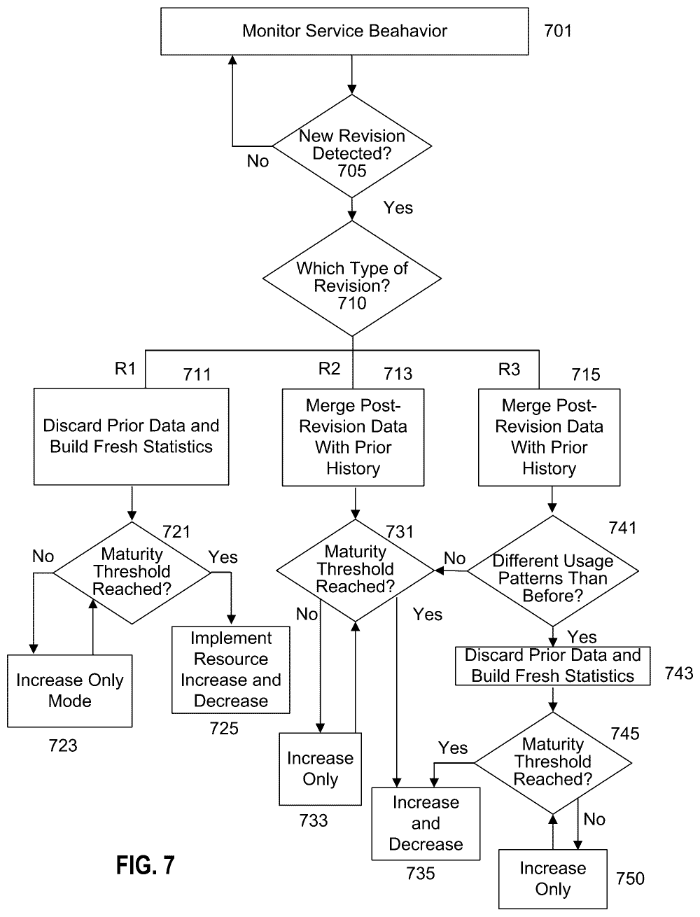

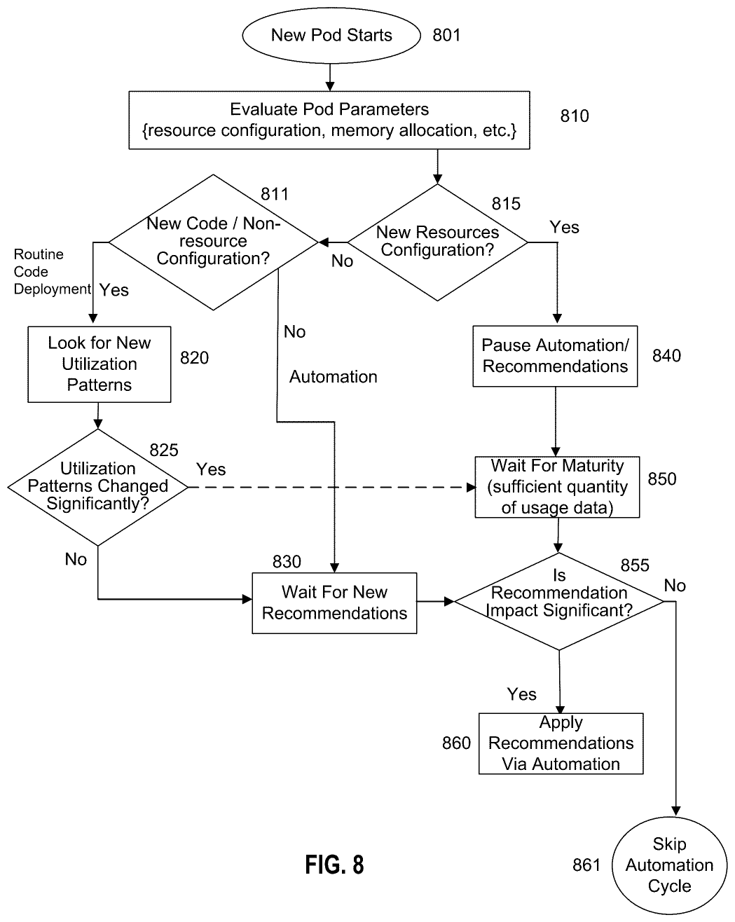

At block 220, revisions applied to the computerized system (e.g., computerized system 150 of FIG. 1) which indicate a possible change in the resources usage of the computerized system may be identified. According to some aspects, the identification of revisions is performed continuously. Revision applied to a computerized system may refer, for example, to revisions applied to one or more or all applications executed, or operated by the computerized system and its associated or allocated computing resources. Such revisions may include, but not limited to, a change in resource allocation initiated by a user instruction (e.g., as opposed to a change in resource allocation following or according to a recommendation outputted via the disclosed systems or methods), a code revision, a change in hardware or a combination thereof. Further details on example revision types are described below with reference to FIGS. 7 and 8.

According to some aspects, one or more operations may be defined or predefined as revisions which indicate a possible change in the resources usage of the computerized system. According to some aspects, the type of one or more operations defined or predefined as revisions which indicate a possible change in the resources usage of the computerized system may be selected from changes applied to code, changes applied to resources allocation, or changes applied to hardware of the computerized system. According to some aspects, revisions performed via a user input are defined as revisions which indicate a possible change in the resources usage of the computerized system. According to some aspects, a revision is identified as a revision which indicates a possible change in the resources usage of the computerized system if the revision is performed via a user input. For example, changes applied to resources allocation via the disclosed systems or methods, may not be identified as revisions which indicate a possible change in the resources usage of the computerized system. An application of a recommendation by the disclosed resource allocation is based on past or ‘up to now’ information or behavior of the computerized system and aimed at adapting the number of resources available to the computerized system to the identified behavior. As such, the application of the recommendation is not a revision which indicates a possible change in the usage of resources by the computerized system. However, a user input, such as user 160 of FIG. 1, may be considered as driven by or based on information referring to future or anticipated requirements of the computerized system and thus should be referred to as a revision which indicates a possible change in the resource usage of the computerized system. In other aspects, a revision may be identified as a revision that indicates a possible change in resource usage even if not implemented by a user, but rather implemented by an orchestration system, or an autoscaler operating “on top of” or in conjunction with, such an orchestration system. More details on this type of “R3” revision are described below.

At block 230, changes in the usage of resources by the computerized system (e.g., system 150) may be identified. The identification of the changes in the usage of resources may be performed based on the recorded utilization data and with respect to the identified revisions.

According to some aspects, the identification of changes in the usage of resources by the computerized system over time is based on the identification of one or more patterns of the utilization data.

Accordingly, the identification of changes in the usage of resources by the computerized system may include processing of the utilization data recorded over periods of time to identify the one or more patterns in the utilization data. According to some aspects, the processing may be performed continuously over separate or overlapping periods of time. According to some aspects, the periods of time may be of a predefined extent of time, such as 30 days, 15 days, or 7 days. In general, this is a configurable parameter, and in some embodiments it may be set anywhere between 3-45 days. According to some aspects, all the periods of time may be of the same predefined extent of time or each such period of time or a specific group or type of periods of time may be of an extent of time selected, e.g., from a set of predefined periods of time.

According to some aspects, the processing of the utilization data may be performed once in a predefined time interval. Each such processing performed at the predefined time interval may be performed with respect to a period of time ending at the time of initiation of the processing. For example, such processing may be performed every ten minutes with respect to a period of time of 30 days ending at the specific time of processing. Accordingly, the periods of time are in the form of a sliding window having a predefined width (for example, 30 days).

According to some aspects, the utilization data may be repeatedly accumulated, at a predefined time interval (e.g., every 30 seconds), at the computerized system (e.g., at system 150 of FIG. 1, for example, by a memory element located at system 150). The accumulated usage data may be then transferred to the disclosed systems (e.g., to storage device 120 or memory 125 of system 100 of FIG. 1) every predefined time interval (e.g., every ten minutes). Once received by an example system (e.g., system 100 of FIG. 1), the new accumulated data (e.g., recorded during the last ten minutes) is added to the previously accumulated data to generate utilization data recorded during the most recent predefined period of time (e.g., the last 30 days).

According to some aspects, the one or more patterns which may be identified in the utilization data recorded over a period of time may include at least one pattern of the type of a seasonality pattern or a trend pattern. A seasonality pattern may refer, for example, to usage data which exhibits regular and predictable changes that recur or repeat every specific time, e.g., every weekend. A trend pattern may refer, for example, to a general change in the usage data over a period of time, such as memory usage increase over a month. A pattern may describe when a variable (e.g., memory usage) changes in a repeating or predictable way.

According to some aspects, the one or more patterns of the utilization data which may be identified may include anomalies. Anomalies may refer, for example, to resource usage that deviates from what is standard, normal, or expected.

According to some aspects, each period of time may be associated with a revision and each revision may be associated with one or more periods of time. According to some aspects, a period of time may be associated with the most recent revision applied until the end of the period of time. Thus, for example, if one or more revisions are applied during a period of time then the period of time will be associated with the most recent revision applied during the period of time. If no revisions were applied during a period of time then the period of time may be associated with the most recent revision applied before the beginning of the period of time. According to some aspects, a period of time associated with a revision may begin prior to the application of the associated revision, at the application of the associated revision or after the application of the associated revision and until the application of a further revision. A period of time which begins prior to the application of the associated revision includes historic usage data with respect to the associated revision. Processing of historic usage data may allow, at least in some cases, an earlier identification of a revision as an operative revision, e.g., within a relatively short time (e.g., less than the predefined period of time or less than half of the predefined period of time) after the application of the revision.

According to some aspects, a period of time associated with a revision determined as an operative revision may include periods of time associated with revisions applied after the application of the operative revision and prior to the application of the following operative revision and which were determined to be non-operative revisions. According to some aspects, a revision may be determined as a non-operative revision if it is not determined as operative revision, and it is not the most recently applied revision. This is since all the utilization data recorded during periods of time associated with the revision were processed or analyzed and found not to affect the resource usage of the computerized system.

According to some aspects, the identification of changes in the usage of resources by the computerized system may further include the determination of a revision of the identified revisions as an operative revision. A revision may be determined as an operative revision if the revision is determined as affecting the resources usage of the computerized system at least with respect to the previously applied identified revision. According to some aspects, only an operative revision may trigger the calculation and output or application of an allocation recommendation. According to some aspects, an identified revision may be determined as an operative revision if the identified revision is determined to affect the resources usage of the computerized system with respect to the most recent determined operative revision.

According to some aspects, the determination of a revision as affecting the resources usage of the computerized system with respect to at least the previously applied identified revision may include comparing between identified one or more patterns of the utilization data over a period of time associated with the revision and over a period of time associated with the previously applied identified revision. According to some aspects, if the difference between the one or more patterns is above a threshold, then the revision may be determined as affecting the resources usage of the computerized system and thus determined as an operative revision. According to some aspects, this comparison may be performed in a continuous manner, e.g., once in a predefined time interval. The comparison with respect to the specific revision may be performed continuously (e.g., once in a predefined time interval) until a new revision is identified or until a new operative revision is identified. According to some aspects, the comparison may be performed between one or more periods of time associated with the revision and one or more periods of time associated with the previously applied revision or the previously applied operative revision. According to some aspects, the comparison may be performed between the most recent period of time, a period of time ending near the time of the performance of the comparison or a period of time starting at the application of the revision, and the most recent period of time associated with the previous revision or with the most recent operative revision or a period of time starting at the application of the previous revision or at the application of the most recent operative revision or a period of time ending near the application of the revision, or a combination thereof. According to some aspects the periods of time compared overlap or when combined may form a single continuous period of time. If a period of time associated with a revision is compared with a period of time associated with the most recent operative revision, then it may be compared with a period of time during which one or more revisions were applied, following the operative revision, and which were determined as non-operative revisions (e.g., determined as non-affecting the resource usage of the computerized system).

According to some aspects, utilization data recorded during a period of time is determined as significant with respect to its associated revision based on the extent of the portion of the period of time starting from the application of the associated revision. According to some aspects, a threshold may be determined for a minimal duration of time for recording utilization data following the application of the associated revision. This minimal duration of time would typically be shorter than the predefined period of time. For example, if the period of time begins prior to the application of the associated revision (e.g., including historic data) then a portion of the recorded utilization data, recorded during a portion of the period of time beginning at the application of the associated revision, is reviewed to determine significancy with respect to the associated revision. If this portion of the period of time is shorter than the minimal extent of time, then the utilization data recorded during the period of time is determined as not significant. If the period of time begins at the application of the associated revision or following that, then the utilization data recorded during this period of time is significant. According to some aspects, the significancy may be determined based on alternative or additional relevant characteristics, such as the runtime of an application per a period of time (e.g., a day). Applications having more runtime per a period of time have more utilization data accumulated per the period of time with respect to other applications. The minimal duration of time to determine significancy may be therefore different, e.g., shorter, for such applications.

According to some aspects, once a new revision is applied, the first period of time associated with the revision compared with a period of time associated with the previous revision applied or with the most recent operative revision applied may include historic data or both periods of time may overlap. According to some aspects, in such a case, if the compared periods of time were not identified as different to trigger an operative revision event but on the other hand, are not also determined as similar (e.g., the utilization data is not similar or the identified one or more patterns are not similar, for example, with respect to a determined similarity threshold), then the next periods of time associated with the revision which will be processed will not include historic data, e.g., will start at the time of application of the revision or following that.

According to some aspects, the extent of the effect of an operative revision (or the level of sensitivity to changes of the resource allocation), e.g., with respect to the computerized system resource utilization prior to the application of the revision, may be predefined. According to some aspects, the extent of the effect may be selected by the user. According to some aspects, the extent of the effect may be predefined as a parameter or rule of a set of rules defined as a mode of operation to be selected by the user. According to some aspects, a revision may be rechecked for being an operative revision based on further recorded utilization data, e.g., once in a predefined time interval, and as long as a new revision is not identified.

According to some aspects, the determination of a revision as an operative revision may be performed based on various considerations or different types of information other than utilization data. For example, a change in resource allocation performed via a user input having a value different from the value of the last resource allocation performed by a user input may be defined as an operative revision. According to some aspects, a change in resource allocation performed via a user input may be defined as an operative revision only if it has a value different from the value of the last resource allocation performed by a user input. This may be applied, for example, to prevent a user change in resource allocation (e.g., performed by a user, such as user 160 of FIG. 1) aimed at reinstalling a previous resource allocation initiated by the user, to be determined as an operative revision and following that, changing of the user desired allocation. A reinstallation of a previous resource allocation initiated by a user may be required, for example, if this allocation was automatically changed by the disclosed resource allocation (e.g., via system 100 of FIG. 1 or method 200 of FIG. 2).

Continuing with reference to FIG. 2, at block 240, following the identified changes in the resources' usage, recommendations for resource allocation may be calculated, respectively. For each identified change, a corresponding resource allocation may be calculated. According to some aspects, the calculation of the recommendations for resource allocation are performed based on the recorded utilization data and with respect to the identified revisions. For each change identified e.g., by determining an identified revision as an operative revision, a recommendation for resource allocation may be calculated based on the utilization data recorded in one or more periods of time associated with the revision. According to some aspects, the recommendation is calculated based on the identification of the one or more patterns of the utilization data recorded over a respective one or more periods of time. According to some aspects, for the purpose of the calculation of the recommendation, only utilization data recorded starting from the application of the revision may be considered (e.g., not including historic data with respect to the revision).

According to some aspects, more than one recommendation may be calculated and applied with respect to the same operative revision. Following the determination of an operative revision and after the calculation and output or application of a recommendation, further or later periods of time associated with the operative revision may be processed and compared as disclosed herein and additional recommendations may be calculated. If a further calculated recommendation with respect to an operative revision is different than the first or previous recommendation calculated and output for the operative revision, then the new different recommendation may be output or applied. According to some aspects, this may be repeated, e.g., until a new revision is identified or until a new operative revision is determined. This may happen, for example, when a revision is determined as an operative revision and a recommendation with respect to the revision is output relatively close after the application of the revision. At such a stage, the full breadth of the usage resources effect may not yet to be expressed or revealed.

According to some aspects, a change in resource allocation performed in accordance with and following a recommendation calculated according to the disclosed resource allocation is not identified as a revision which indicates a possible change in the resources usage of the computerized system.

According to some aspects, method 200 may further include receiving an operation mode selected by a user. The recommendation for resource allocation may be further calculated based on or in accordance with the selected operation mode. According to some aspects, the operation mode may be selected from a plurality of predefined operation modes. According to some aspects, the plurality of predefined operation modes may extend from a maximal saving operation mode to a guaranteed performance operation mode. A maximal saving operation mode, with respect to other operation modes, may be more directed at saving costs while, e.g., increasing resource allocation may be performed in a more restrictive manner. A guaranteed performance mode, with respect to other operation modes, may be more directed at securing performance and thus, for example, may be less restrictive when increasing resource allocation. Further or other operation modes, including one or more intermediate operation modes between a maximal saving mode and a guaranteed performance mode may be predefined or allowed. An operation mode may include various respective rules or parameters referring to different aspects of the disclosed resource allocation.

Finally, at block 250, the calculated recommendations may be output, after which method 200 ends. According to some aspects, outputting of the recommendation may include displaying the recommendation to a user, e.g., user 160 of FIG. 1, for example, via a UI of system 100. The user may then select if to apply the recommendation or not. According to some aspects, a recommendation is output only if the utilization data recorded during the respective period of time is significant with respect to its associated revision. This may be determined to prevent recommendations which are not well substantiated. A recommendation which is based on utilization data recorded during a period of time which most of it was recorded prior to the application of the associated revision (e.g., historic data), may lead to erroneous or inaccurate conclusions.

According to some aspects, outputting the recommendation may include automatically causing the application of the recommendation to the computerized system, such as computerized system 150. According to some aspects, the resource allocation recommendation may be applied automatically only if predefined conditions are met. For example, if the recommendation is to increase or decrease a current allocation by up to x percentages or by up to y resources or up to threshold z, then the recommendation is applied automatically. However, if the recommendation is to increase or decrease the current allocation by above x percentages or by above y resources or by above a threshold z, then the recommendation requires user confirmation. Such conditions may be predefined by the user or may be a part of a set of rules or a mode of operation selected by the user. According to some aspects, the recommendation may be automatically applied via a supervising system (not specifically shown in FIG. 1) of computerized system 150 or via orchestration system 180.

The computerized system may execute multiple applications during its operation while each application has its resource allocation. The disclosed resource allocation may be then applied to each application and recommendations may be calculated and output for each application, respectively.

According to some aspects, a recommendation for each application may be calculated (alternatively or additionally) based on the impact of the recommendation. The impact may include, for example, a financial impact. According to some aspects, the total impact of the recommendation may be considered, e.g., with respect to the entire computerized system or a portion of it. For example, the total impact may be calculated with respect to all of the applications currently operated by the computerized system or with respect to a specific portion of the operated applications. According to some aspects, the total impact may be considered with respect to each single recommendation or with respect to a plurality of associated recommendations output within a predefined time interval. According to some aspects, the recommendations are recommendations to decrease the resource allocations.

As one may know, a decrease in resource allocation may carry some risk. However, for example, when the financial impact of the decrease in the resource allocation is considered, it may be determined, e.g., based on predefined rules, conditions, formulas, or any other logic or technique, that the extent of the financial saving does not justify the increase in risk or the decrease in the system's resiliency. [Can we provide a suggested or preferred algorithm for this determination?] In such a case, the disclosed resource allocation may output a recommendation or a final recommendation (e.g., after considering the financial impact) to leave the current allocation as is. Although the financial impact may be particularly beneficial when considering recommendations for resource allocation decrease, it may also provide an advantage when considering a recommendation for resource allocation increase. Considering the recommendation impact when calculating or determining a recommendation for resource allocation may better or optimize the resource allocation and therefore the resiliency and performance of the computerized system.

According to some aspects, the considered impact of a recommendation may refer to parallelization factors. A recommendation may be calculated and applied to all replicas of a specific application (e.g., an authentication service having 200 replicas. For example, a single replica out of the 200, which requires additional memory resources, may not justify increasing the memory allocation for all the 200 replicas.

According to some aspects, method 200 may further include monitoring the utilization of resources by the computerized system or the recorded utilization data, e.g., to identify resource utilization which is higher than the currently applied resource allocation. If the usage of one or more resources by the computerized system is determined as higher than the one or more resources applied allocation, a recommendation to increase the one or more resources applied allocation, may be output, respectively. According to some aspects, the output of the recommendation to increase the applied allocation of the respective one or more resources may include automatically applying the recommended allocation to the computerized system, such as computerized system 150, e.g., via orchestration system 180.

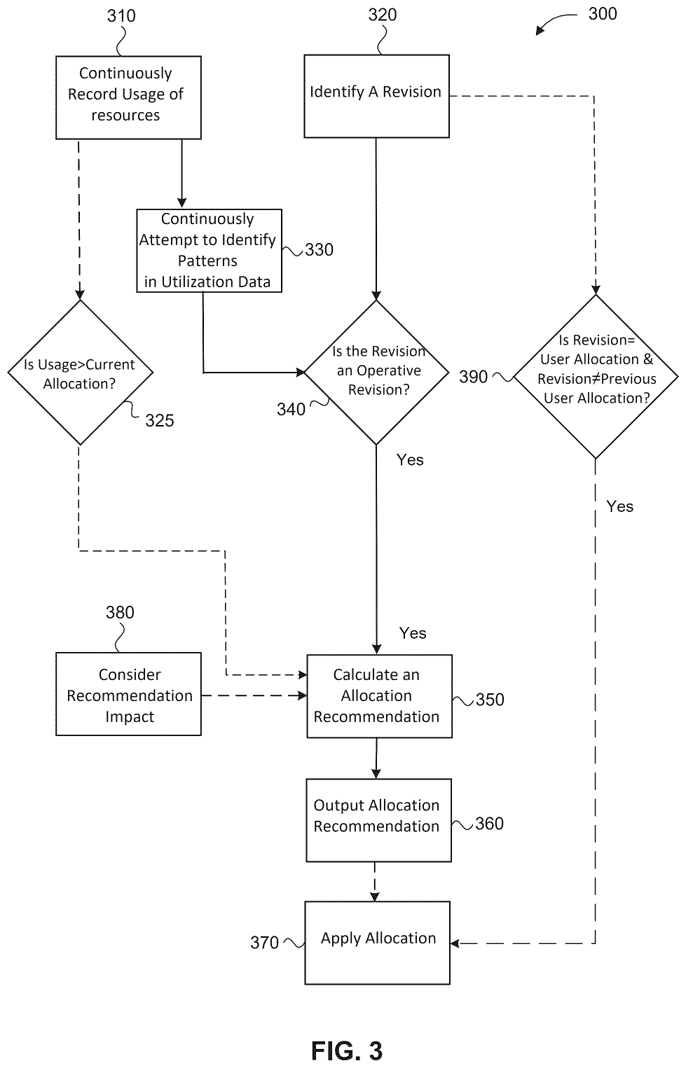

Reference is now made to FIG. 3, which shows a process flow diagram 300 of exemplary procedures for optimizing resource allocation of a computerized system or environment. The procedures of FIG. 3, and as will be further detailed hereinbelow, may be performed by the disclosed resource allocation. The procedures of FIG. 3 may be applied, inter alia, via methods such as method 200 of FIG. 2 or method 500 of FIG. 5 and/or by systems such as system 100 of FIG. 1.

With reference to FIG. 3, at block 310, usage of resources by the computerized system is continuously recorded. At block 320, a revision which is applied to a computerized system (e.g., computerized system 150 of FIG. 1) and indicates a possible change in the computerized system resources usage is identified. At block 330, a continuous attempt for identifying patterns in the utilization data recorded at block 310 during periods of time associated with the revision is performed. For example, every predefined number of minutes, usage data recorded during an extent of time of 30 days ending at the respective time may be processed to identify predefined one or more patterns. Each such period of time is associated with the revision as long as it is the most recently applied identified revision.

At query block 340, it is determined if the revision is an operative revision. If “Yes”, then process flow moves to block 350, where a recommendation for resource allocation is calculated. If the predefined one or more patterns are identified in a processed period of time associated with the revision then the identified patterns are compared to the patterns identified in one or more periods of times associated with the most recently applied operative revision. For example, the predefined one or more patterns identified in the processed period of time associated with the revision are compared with patterns identified in the most recent period of time associated with the most recently applied operative revision. If the compared patterns are determined as different (e.g., the difference between the compared patterns is above a predefined threshold), then the revision is determined as an operative revision. As long as no new or a further revision is applied, this process continues or is iterated, each time for utilization data recorded during a different period of time (e.g., a more recent one).

At block 350, the calculation is performed based on utilization data associated with the operative revision. In embodiments, the calculation may be based on the patterns or at least one of the patterns identified in utilization data associated with the revision. The calculation may be based on the utilization data recorded during the associated period of time which was found to exhibit a change in resource usage. Alternatively, or additionally, the calculation may be based on the utilization data recorded during a period of time beginning at the application of the revision. From block 350, process flow proceeds to block 360.

At block 360, the recommendation is output, e.g., for a user's review, such as user 160. For example, the recommendation is displayed to a user, on a display of the computerized system. The recommendation may be output to the user via a UI, such as UI 130. UI 130 may be a web-based application providing, inter alia, resource allocation recommendations for computerized system 150 accessed and viewed by user 160 via a display and Input/Output (I/O) devices of computerized system 150. The user may then approve or disapprove the recommendation. Alternatively, or additionally, the recommendation may be output to the computerized system or to the orchestration system. The user may then review the recommendation via the computerized system or via the orchestration system.

According to an optional block 370, the resource allocation recommendation may be automatically applied to the computerized system (e.g., without user confirmation).

As shown in block 325, the computerized system resource utilization or the recorded resource utilization according to phase 310 is continuously monitored to check if the utilization is higher than a current resource allocation. If the resource utilization is higher than a current resource allocation then the disclosed systems and methods automatically calculate and output a resource allocation to match or satisfy the demand for more resources. The recommendation to increase allocation to meet current demand may be applied automatically.

At block 390, which is a parallel path following block 320, if the identified revision includes a user-initiated change of current resource allocation (e.g., initiated by user 160 of FIG. 1), and the user-initiated allocation is different than the allocation previously applied by the user (i.e., {Revision=User Allocation AND Revision!=Previous User Allocation}, as shown in FIG. 3), than the revision is considered as an operative revision. Since the change in resource allocation is initiated by the user, it may be immediately applied to the computerized system.

According to another optional block 380, in embodiments, the impact of the recommendation may also be considered when calculating, or when determining, the recommendation. The impact may include, for example, a financial impact.

The methods or processing described with respect to FIG. 2 and FIG. 3 may be applied, for example, via instructions or code stored in storage 120 or memory 125 of system 100 of FIG. 1 and to be executed, e.g., by processor 110.

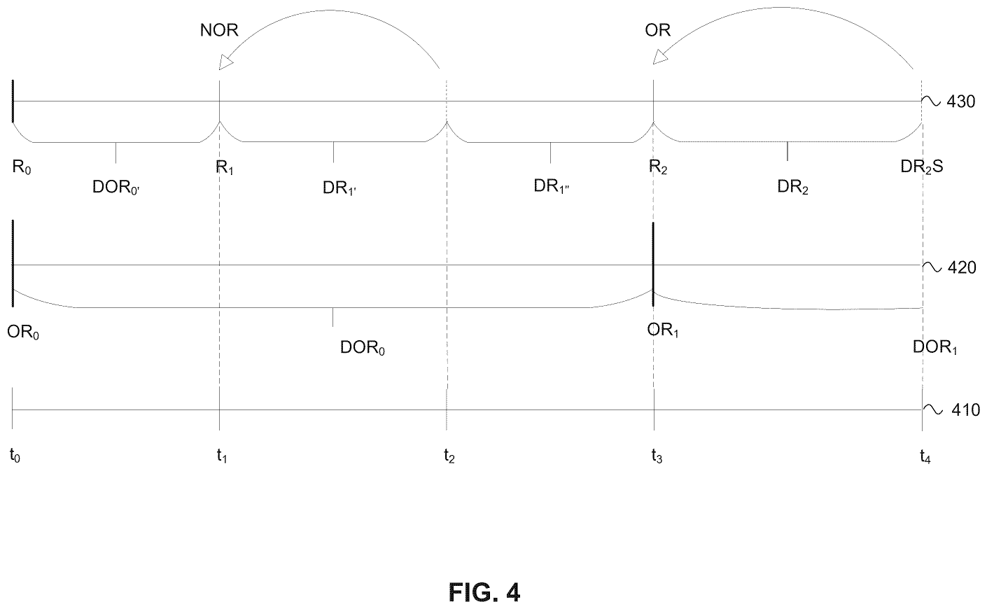

Referring to FIG. 4, there is shown an illustration exemplifying identification of revisions, indicated “R”, and determination of operative revisions, indicated “OR” along a timeline 410. FIG. 4 shows additional timelines, an operative revision timeline 420 indicating events relating to operative revisions and a revision timeline 430 indicating events relating to revisions. At a time t₀, a revision R₀ was applied. R₀ was determined as an operative revision indicated OR₀. At a time t₁, a revision R₁ was applied. Utilization data recorded from the time operative revision OR₀ was applied (t₀) until revision R₁ was applied (t₁) is indicated DOR_{0′}. DOR_{0′} is associated with R₀ and OR₀ (while R₀=OR₀). At a time t₂ R₁ is checked for being an operative revision based on utilization data recorded until t₂, e.g., DOR_{0′} and DR_{1′}, while DR_{1′} indicated the utilization data recorded from the time revision R₁ was applied (t₁) and until time t₂. DR_{1′} is associated with revision R₁. At time t₂, a period of time associated with revision R₁ may be processed. The period of time may include historic data included in DOR_{0′} recorded prior to the application of R₁, e.g., prior to time t₁. The period of time may end at t₂, and start at t₁ or prior to t₁, thus including all the utilization information recorded since R₁ was applied, e.g., including DR_{1′}. The utilization data in the selected or defined period of time is processed and one or more patterns are identified. The patterns may be then compared to patterns identified in a previous period of time associated with OR₀, e.g., the period of time beginning at time t₀ and ending at time t₁ including data DOR_{0′}. If the period of time associated with R₁ includes historic data then the two compared periods of time overlap. According to the comparison performed at time t₂, the compared patterns were determined similar and therefore revision R₁ was not determined as operative revision at time t₂ (Not Operative Revision (NOR)). Further such processing and checks for change in the utilization data may be performed with respect to revision R₁ until a new revision or a further revision R₂ is applied at time t₃. The additional processing with respect to R₁ did not exhibit any change in the resource usage until the application of revision R₂ and therefore revision R₁ was determined as a non-operative revision. Utilization data recorded at a period of time beginning at time t₂ and ending at time t₃ is indicated DR_{1″}. Data DR_{1″} is associated with revision R₁ and operative revision OR₀.

A check for changes in the resource usage following the application of revision R₂ is performed at a time t₄. Utilization data recorded from the application of revision R₂ at time t₃ until time t₄ is indicated DR₂. The check is performed with respect to utilization data recorded during a period of time beginning at t₃ and ending at t₄ associated with revision R₂ and thus including data DR₂. The period of time is processed, and one or more patterns are identified. The period of time is compared with a period of time associated with revision R₁ or with operative revision OR₀. For example, a period of time beginning at time t₂ and ending at time t₃. The two compared periods of time form, when combined, a continuous period of time beginning at t₂ and ending at t₄. The compared patterns are determined as different and revision R₂ is determined as an operative revision OR₁. With reference to timeline 420, the utilization data recorded from time t₀, when operative revision OR₀ was applied until time t₃, when operative revision OR₁ was applied is associated with operative revision OR₀ and thus indicated as Data of OR₀ (DOR₀). Data recorded beginning at the time operative revision OR₁ was applied, time t₃ and at least until time t₄, since no further revision was applied, is indicated Data of OR₁ (DOR₁). Following The determination of OR₁, a recommendation for resource allocation was calculated. The utilization data, based on which the recommendation was calculated, was accumulated during a period of time beginning at t₃ and ending at t₄. The duration of time of this respective period of time equals t₄−t₃. Since t₄−t₃≥TH, where TH is a threshold determining minimal value of time duration for significancy, then the calculated recommendation is output. According to some aspects, if the usage data accumulated during a time period based on which a recommendation was calculated, then the associated revision is not determined as an operative revision.

Reference is now made to FIG. 5, which is a process flow diagram 500 of another method for optimizing resource allocation of a computerized system, such as computerized system 150 of FIG. 1. Method 500 may be implemented by the disclosed systems such as system 100 of FIG. 1. The steps of method 500 may be applied, for example, via instructions or code stored in storage 120 or memory 125 of system 100 and executed by processor 110 of system 100.

Referring now to FIG. 5, at block 510, utilization data including data with respect to the usage of resources by the computerized system, such as computerized system 150 of FIG. 1, over time may be recorded. The utilization data may be continuously recorded. According to some aspects, the utilization data may be recorded as described with respect to block 210 of FIG. 2.

At block 520, recommendations for resource allocation for the computerized system may be calculated. The recommendations may be calculated based on the recorded utilization data. The calculation may include consideration of the recommendations impact on the computerized system performance in view of the recommendations financial impact.

According to some aspects, the total financial impact of the recommendation may be considered, e.g., with respect to the entire computerized system or a portion of it. For example, the total financial impact may be calculated with respect to all of the applications currently operated by the computerized system or with respect to a specific portion of the operated applications. According to some aspects, the total financial impact may be considered with respect to each single recommendation or with respect to a plurality of associated recommendations output within a predefined time interval.

According to some aspects, the recommendations are recommendations to decrease the resource allocations. Although the financial impact may be particularly beneficial when considering recommendations for resource allocation decrease, it may also provide an advantage when considering a recommendation for resource allocation increase.

At block 530, the recommendation may be output. According to some aspects, the output of the recommendations may be performed as described with respect to block 250 of FIG. 2.

According to some aspects, method 500 may further include, for each application operated by the computerized system, monitoring of the utilization data or the recorded utilization data with respect to each such application, if the usage of one or more resources by the application is determined as higher than the resources applied allocation, method 500 may further include automatically increasing the resources applied allocation, respectively.

According to some aspects, method 500 may further include, for each application operated by the computerized system, the identification of revisions applied to the computerized system which indicate a possible change in the computerized system resources usage. According to some aspects, the revisions identification may be performed as shown in block 220 of method 200, of FIG. 2. Method 500 may further include, for each application, identification of changed in the usage of resources by the computerized system over time. According to some aspects, the identification of such changes may be performed as shown at block 230 of method 200.

According to some aspects, the identification of changes in the usage of resources may be performed based on the recorded utilization data and with respect to the identified revisions and as further described with respect to method 200. According to some aspects, the calculation of the resource allocation recommendations may be further performed with respect to the identified revisions, as further described with respect to method 200.

According to some aspects, the processing method 200 of FIG. 2 may be applied in addition to the processing of method 500 of FIG. 5, mutatis mutandis.

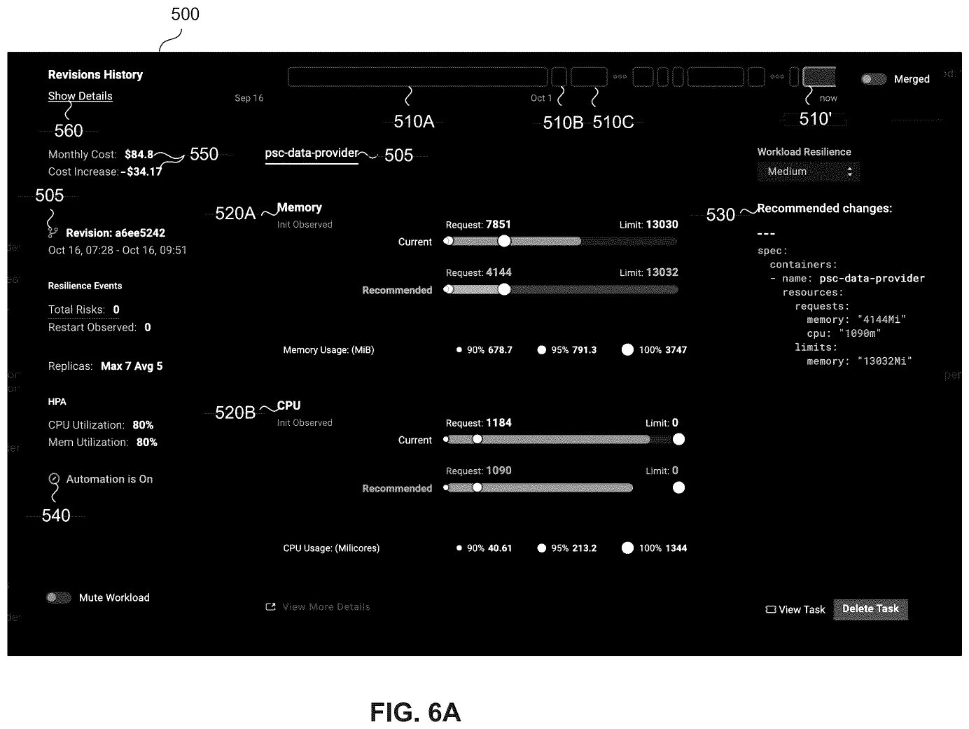

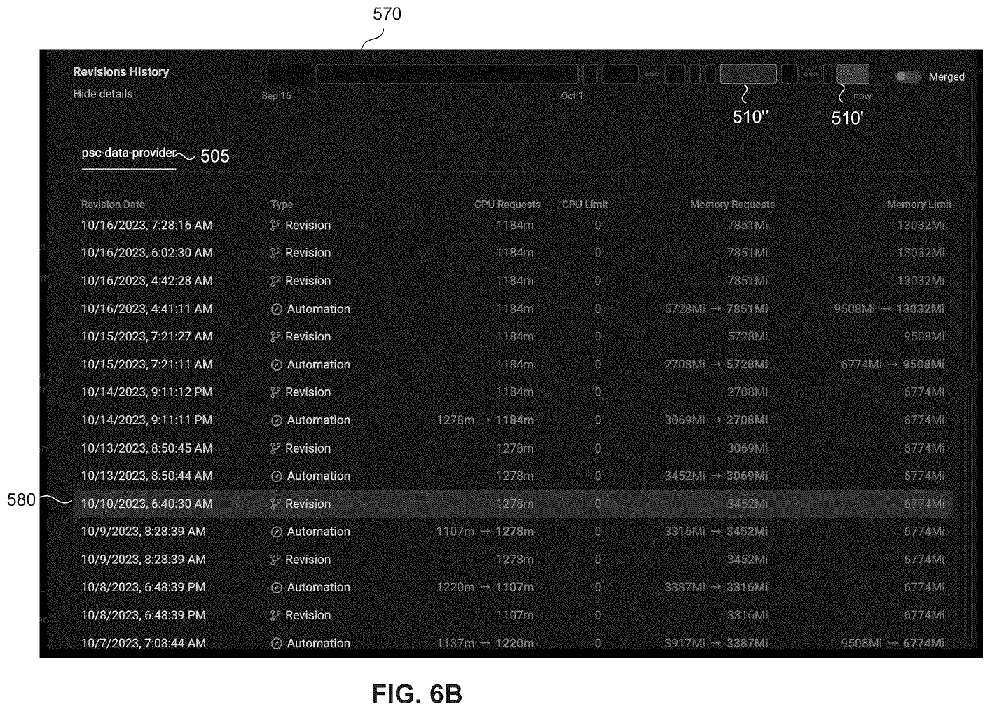

Reference is now made to FIG. 6A, which shows an exemplary screen 500 of an exemplary GUI presenting resource usage of a microservice 505 executed by a computerized system, associated with a current revision, and a respective resource allocation recommendation. The GUI may be used as the UI of the disclosed systems allowing interaction of a user with the disclosed systems, such as UI 130 of system 100 used by used by user 160 according to FIG. 1. The interaction may include, for example, providing input to the disclosed systems or according to the disclosed methods such as selection of the mode of operation and receiving output, such as recommendations for resource allocation.

Screen 500 includes subsequent elements 510A, 510B, 510C and so forth which indicate revisions applied over time. Revision 510′ is the revision currently applied, and accordingly, its details are presented in screen 500. A serial number 505 identifying the revision and further details, e.g., time duration associated with the revision, are presented. Screen 500 presents information with respect to resources which include memory 520A and Central Processing Unit (CPU) 520B. Additional types of resources may include storage, network or Graphics Processing Unit (GPU). For each resource there is shown an indication of current allocation and an indication of recommended allocation, e.g., via a bar element. The current allocation and recommended allocation may be shown with respect to a determined limit for the resource allocation. Furthermore, for each resource the amount of usage associated with the selected revision, e.g., memory in Mib and CPU in Millicores is also indicated, e.g., by percentages of time.

Screen 500 further presents cost indications 550. Cost indications 550 include a monthly cost indication and a cost increase indication. The monthly cost indicates the cost of resource allocation for the past month. The cost increase indicates the increase or saving in cost if the recommended resource allocation is applied.

An indication 540 indicated if automation is on or off. In screen 500 the automation is turned on and thus the recommended resource allocation is applied to the computerized system automatically. Code 530 may be suggested for applying the recommended resource allocation manually, e.g., if automation 540 is turned off. A navigation element 560 leading to revision history of the current revision, shown in FIG. 5B, is also presented.

Reference is now made to FIG. 6B, which shows an exemplary screen 570 of the GUI of FIG. 6A presenting the revision history of the current revision presented in FIG. 5A. Screen 570 presents the subsequent elements indicating the revisions applies over time and until element 510′ which indicated the current revision applied. Element 510″ is a historical revision which is selected in the list of historical revisions and indicated there as revision record 580. The first revision in the list is the current revision presented in FIG. 5A.

FIGS. 7 and 8, next described present an alternate embodiment, where three types of revisions are dynamically identified, and handling logic is implemented based on the identified revision type. In response to each identified revision type, a maturity threshold is used, and which types of autoscaler recommendations are implemented following the revision, and for how long, depends upon whether the maturity threshold has been reached (i.e., the full window of data for that revision type has been acquired) or not. Prior to describing the details of the processing of FIGS. 7 and 8, some context is first provided.

### Service Revisions

For purposes of this disclosure, any change that can shift a service's behavior—whether it's a code commit, a configuration tweak, or an autoscaler resource change—is known as a revision. By recognizing each revision as its own event, in embodiments, an exemplary engine can precisely track and compare like-for-like workload histories before making right-sizing decisions.

In embodiments, systems according to the present disclosure seek to optimize resource allocation in container orchestration frameworks, such as, for example, Kubernetes. In embodiments, exemplary systems refine standard container right-sizing by automatically adapting recommendations to each revision (version) of the container—and by learning only from comparable workload versions. Unlike static, time-based windows, engines according to exemplary embodiments may, for example, instantly recognize whether a revision was a major owner-driven spec overhaul, a routine code push, or an autoscaler system's vertical tweak, and may adjust its recommendation and automation strategy accordingly—never shrinking too soon after big changes, and only down-scaling when there is sufficient consistent data.

In embodiments, any change that can shift a service's behavior—whether it is a code commit, a configuration tweak, or an autoscaler resource change—is known as a revision. Accordingly, that nomenclature is utilized throughout this disclosure. By recognizing each revision as its own event, exemplary engines can precisely track and compare like-for-like workload histories before making right-sizing decisions. Such functionality is referred to as “revision awareness.”

In embodiments, three types of revision are identified, and once detected, tailor-made responses to each are implemented. Table A below summarizes the three types of revisions which are dynamically identified and acted upon, according to various embodiments.

TABLE A

| | Code | Spec | Autoscaler | |
|---|---|---|---|---|
| Revision Type | Change | Change | Change | Handling Logic |
| R1: Major Spec | No | Yes | No | Discard prior data; |
| Update | | | | build fresh stats until |
| | | | | maturity threshold. |
| R2: Routine Code | Yes | No | No | Merge with prior |
| Deployment | | | | history; full |
| | | | | up-and-down |
| | | | | recommendations once |
| | | | | maturity is reached. |
| R3: Autoscaler | No | No | Yes | Merge history but stay |
| Adjustment | | | | “increase-only” until |
| | | | | maturity threshold |
| | | | | elapses. |

### Kubernetes Container Right Sizing

Kubernetes is a container orchestration framework that enables running hundreds or thousands of services across a cluster of machines. Each service runs in isolation within containers sharing host resources. To ensure fair scheduling and stable performance, every container must define:

Requests: The guaranteed resources (CPU, memory, GPU) reserved for the container; and Limits: The maximum resources the container may consume, allowing bursts into unallocated capacity while preventing any single container from monopolizing the host.

Incorrect request/limit settings can lead to:
Over-provisioned requests: Wasted capacity and higher costs when services reserve more than they actually need;
Under-provisioned requests: Resource starvation or unpredictable behavior when services compete for unreserved resources;
Under-provisioned limits: Out-of-memory kills or CPU throttling, causing restarts or degraded performance; and/or
Over-provisioned limits: Ineffective isolation, allowing “noisy neighbors” to exhaust host resources.

Therefore, right-sizing containers is critical for maintaining performance, stability, and cost efficiency.

### Container Right Sizing Strategies

In embodiments, effective right-sizing relies on analyzing historical usage and adapting to changing workloads.

Service owners can use observability tools (such as, for example, Grafana, Datadog, new relic., etc.) that visualize past usage and set resources according to the need. However, this is a manual process that does not fit well with a continuous delivery pattern (where new revisions are deployed multiple times per day).

Some open source (e.g., Kubernetes VPA) and commercial solutions operate in the vertical autoscaling space. The common approach is to set up the desired usage percentile. For example: a 50th percentile of usage=X, means that 50% of the time, usage was below X. Existing market tools, such as Kubernetes VPA (vertical pod autoscaler) uses a decay histogram, and is essentially completely unaware of revisions. This can lead to incorrect resource allocations for new revisions.

While a good right sizing algorithm takes into account many other inputs (OOMs (“out of memory” events), throttling, on which machines we are running, HPA (Kubernetes Horizontal Pod Autoscaler) and others), usage percentile is the basic logic, and all algorithms rely on it (which makes sense, because it is necessary to know how a service behaved in the past in order to right size it for the future).

One important parameter is the analyzed time window used to generate a responsive recommendation. For example, is the recommendation percentile's (and additional indicators) historical usage based on the last few hours? If not, and some days of data are needed to be used to form a full picture, how many days worth of data should be collected prior to formulating a recommendation? One day, three days, 10 days, or even a month? It is noted that this is a key parameter, because if it is set to be too long—recent changes are ignored. If it is set to be too short, the different usage patterns and seasonality of a service will not be taken into account.

### Revision Aware Recommendations and Automation Engine

In embodiments, revisions and their types (e.g., R1, R2 or R3 in the nomenclature of this disclosure) are dynamically identified and appropriate steps are taken in response.

It is noted that the scope of an example revision aware recommendation, according to embodiments, is software running in containers, orchestrated by Kubernetes. In this context, code is changed and deployed frequently. Sometimes this change is significant and sometimes it is not. Because the software is running in containers, containers need to properly set requests and limits to avoid overprovisioning, under provisioning and noisy neighbor scenarios. Setting container requests and limits is known as “right sizing.”

Right sizing is complex, and needs to take into account multiple parameters and indicators. Two basic inputs are target usage percentile and duration of the analyzed time window.

In embodiments, an exemplary revision awareness algorithm or process automatically decides on a responsive action to a given detected revision by recognizing when revision changes are significant. In embodiments, first, each revision (R1, R2 or R3, as described above) is detected as it occurs. Second, relevant data needed to analyze the revision is selected. For example, for an R1 (significant change) revision, it is understood that prior usage data is irrelevant. Thus, old metrics are purged and new usage statistics are collected. While the new data is being collected and studied, an example autoscaler system operates in “increase only” mode until an appropriate data maturity threshold has been reached, when the patterns inherent in the new, post-revision usage data have been learned. In an increase only mode, recommendations and automation can increase resources but not decrease them until the appropriate data maturity threshold has been reached.

On the other hand, for example, for an R2/R3 revision, it is assumed that the prior usage history is relevant, due to the lesser severity of the revision, which means the pre-revision and post-revision usage data are compatible. As a result, comparable histories may be merged.

Third, and finally, a recommendation and automation implementation is performed. Thus, once the maturity threshold is met, both upward and downward right-sizing may be applied. Notably, this contrasts with conventional solutions, which all use some predefined, static time window. In contrast, algorithms according to exemplary embodiments automatically and dynamically recognize revision types, and, based on that recognition, in embodiments, it is decided which revisions are taken into account.

Thus, as shown above in Table A, any R1 revision is considered as a major change. Revisions before the R1 revision are disregarded, and an exemplary algorithm honors the new resources and starts learning them from scratch—until it reaches the maturity threshold (when sufficient data is obtained to increase and decrease container resources).

In embodiments, it is necessary to recognize when resources were manually changed by a service owner, or whether they were changed by automation, via autoscaler functionality. This is the distinction between an R1 or R2 change, on the one hand, which are user implemented, and an R3 change, on the other, which is implemented by an autoscaler. In embodiments, several strategies may be implemented for different kinds of workloads. For online services (services that are always up and running), an example algorithm distinguishes between original specification resources (which are set by a user) versus pod resources (which are resources that can be changed by a vertical autoscaler).

Sometimes even an autoscaler implemented revision (this is the R3 category) may cause different usage patterns relative to prior revisions. In embodiments, this type of revision may, for example, also be considered as a significant change (and thus equivalent as regards the recommendation, to an R1 revision). If that occurs, in response, an exemplary algorithm switches to increase only mode, as described above.

### EXAMPLES

### Example 1: Revisions Merge

Workload optimization policy is set to “Balanced” or higher tier (production cluster). For this optimization policy, the maturity threshold is set to 7 days.

There are 4 revisions. From time X to time Y, the image has changed. This is a routine code deployment, and thus an R2 revision. From time Y to time Z, an example vertical autoscaler (automation) changed pod resources. From time Z to the current revision, automation again changed pod resources. Thus, revisions Y and Z are R3 revisions.

Going from the present time backwards, the total duration in time of the {current revision+the Z revision+the Y revision} is 6 days, which is below the set maturity threshold of 7 days. Therefore, revision X is also considered, to provide 10 days of statistics. This is more than the defined 7 days, since the additional 3 days (from revision X) belong to an earlier revision that is not significantly different from the current one, and adding the additional duration allows the system to provide a more accurate recommendation.

### Example 2: Handling An R1 Revision

In this example, workload optimization policy is also set to balanced (production cluster). For this optimization policy, the maturity threshold is set to 7 days.

Here, there were four revisions, just as in Example 1. However, in this example, when the service owner deployed revision Y, (s)he explicitly changed the original specification resources (this is now an R1 revision, as shown in Table A). This is automatically recognized as a major change, and previous revisions (e.g., revX—the prior revision to revY) are not considered in collection of statistics used by the recommendation agent. Here again, the time duration of {revCurr+revZ+revY}=6 days, less than the configured maturity threshold. Therefore, because revX may not be used, as it is assumed incompatible with revY's usage, for 1 additional day (until reaching the 7 days maturity window), an example recommendation agent will run in an “increase only” mode.

The following is an example YAML file as seen by an exemplary autoscaler system, according to various embodiments. A Kubernetes deployment YAML file include key components to define how an application is deployed and managed. The essential elements are:

apiVersion: Specifies the API version, typically apps/v1 for deployments.
kind: Defines the resource type, set to Deployment.
metadata: Contains identifying information like name and optional labels.
spec: Outlines the desired state of the deployment, including:
replicas: Number of pod instances.
selector: Match criteria to link the deployment with its pods.
template: Pod template specification containing:
metadata: Pod labels.
spec: Container details such as containers, each with name, image, ports,
and possibly env, volumeMounts, etc.

The example YAML file is as follows, where the bolded portions show the relevant lines that may be taken into account when evaluating revisions, in embodiments:

```
apiVersion: apps/v1
kind: Deployment
metadata:
  annotations:
    deployment.kubernetes.io/revision: “9”
    meta.helm.sh/release-name: eli-demo-test
    meta.helm.sh/release-namespace: eli-demo-test
  creationTimestamp: “2023-07-25T10:02:52Z”
  generation: 10
  labels:
    app: eli-demo-test
    app.kubernetes.io/managed-by: Helm
  name: eli-demo-test
  namespace: eli-demo-test
  resourceVersion: “633707617”
  uid: 1ed4d364-596d-4846-b4fa-366c17c0f091
spec:
  progressDeadlineSeconds: 600
  replicas: 0
  revision HistoryLimit: 10
  selector:
    matchLabels:
      app: eli-demo-test
  strategy:
    rollingUpdate:
      maxSurge: 25%
      maxUnavailable: 25%
    type: RollingUpdate
  template:
    metadata:
      annotations:
        automation.perfectscale.io/restartedAt: “2023-10-12T09:28:09Z”
        kubectl.kubernetes.io/restartedAt: “2023-07-30T00:41:04-04:00”
      creationTimestamp: null
      labels:
        app: eli-demo-test
    spec:
      containers:
      - image: registry.k8s.io/hpa-example
        imagePullPolicy: Always
        name: eli-demo-test
        ports:
        - containerPort: 80
          protocol: TCP
        resources:
          limits:
```

| | |
|---|---|
| memory: 100Mi | (Mebibytes) |

requests:

| | |
|---|---|
| cpu: 10m | (milicores) |

```
            memory: 50Mi
        terminationMessagePath: /dev/termination-log
        terminationMessagePolicy: File
      dnsPolicy: ClusterFirst
      restartPolicy: Always
      schedulerName: default-scheduler
      securityContext: { }
      terminationGracePeriodSeconds: 30
status:
  conditions:
  - lastTransitionTime: “2023-07-25T10:02:53Z”
    lastUpdateTime: “2023-10-12T09:28:11Z”
    message: ReplicaSet “eli-demo-test-7fdfd58696” has successfully
    progressed.
    reason: NewReplicaSetAvailable
    status: “True”
    type: Progressing
  - lastTransitionTime: “2023-10-13T12:08:16Z”
    lastUpdateTime: “2023-10-13T12:08:16Z”
    message: Deployment has minimum availability.
    reason: MinimumReplicasAvailable
    status: “True”
    type: Available
  observedGeneration: 10
```

Next described are two example process flows that illustrate the above description. The methods illustrated in the processing of each of FIGS. 7 and 8 may be implemented by the disclosed systems such as system 100 of FIG. 1. The processing of the methods of FIGS. 7 and 8 may be applied, for example, via instructions or code stored in storage 120 or memory 125 of system 100 and executed by processor 110 of system 100.

FIG. 7 is an example process flow for continuous monitoring of services, detecting revisions and revision type, and handling logic responses thereto, according to various embodiments. FIG. 7 illustrates the three revision types shown in Table A, and their corresponding handling logic, according to various embodiments.

With reference to FIG. 7, process flow begins at block 701, where a given service behavior is monitored by an example system. From block 701 process flow moves to query block 705, which determines if a new revision has been detected. Using the nomenclature of Table A, the new revision may be any of R1, R3, or R3. If “No” is returned at query block 705, then process flow returns to block 701, and the system continues monitoring service behavior.

If, however a “Yes” is returned at query block 705, then process flow moves to query block 710, which determines which type of revision has been detected. Given the discussion above, there are obviously three possible revision types, and each has a specific handling logic. Beginning with the left side of FIG. 7, if the return at query block 710 is “R1”, then process flow moves to block 711, where, because new resources are now implemented by the revision, prior revision data is discarded or purged, and fresh statistics must be built. From block 711, process flow proceeds to query block 721, where it is determined if a maturity threshold has been reached, for example, as in the examples above, this may be 7 days. In general, a maturity threshold, or maturity window (both terms refer to the same concept), is a specific number of days (or fractions of days), N, where N is a positive real number. In some embodiments, N may be anywhere from 3 to 45. In the examples provided below, N is 10. As noted above, in embodiments, the maturity threshold prevents premature and potentially dangerous recommendations by ensuring sufficient data has been analyzed before making changes. In embodiments, the maturity window may be coupled with policy types, such as, for example, “max savings”, “balanced”, “extra headroom” and “max headroom”, with the maturity window for a max savings policy set to three days, and the maturity window for the other policy types set to 7 days. In embodiments the number of days N in a maturity window for a given policy is a configurable parameter.

If “Yes” at query block 721, then there is sufficient data for the autoscaler to make and implement recommendations, and process flow moves to block 725, where both increase and decrease in system resources recommendations may be implemented. If, however, there is insufficient data post-revision, and the maturity threshold has not been reached, then process flow proceeds to block 723, where increase only recommendations are implemented. Process flow continues to loop from block 723 through query block 721, until the data maturity threshold has been reached.

Referring now to the middle path, where at query block 710 an R2 revision was detected, process flow proceeds to block 713, where, as in Example 1 above, post-revision data is merged with pre-revision data, because they are comparable, and process flow moves to query block 731, where it is determined if the maturity threshold has been reached (using the combined time duration of revCurr and prior revs). If “Yes” process flow moves to block 735, where both increase and decrease recommendations of the autoscaler are implemented. However, if a “No” is returned at query block 731, then process flow moves to block 733, where only resource increase recommendations may be implemented by the autoscaler. This situation is similar to Example 2, revCurr, where revCurr is similar in type to that of revZ and revY, but even after combining revCurr with revZ and revY, there is still insufficient data in terms of days to meet the maturity threshold. From block 733, process flow continues to loop through query block 731 until the maturity threshold has been reached, as shown.

Finally, with reference to the rightmost path in FIG. 7, where an “R3” is returned at query block 710. It is recalled that R3 is not a user implemented revision, but one implemented by an autoscaler. From query block 710, process flow proceeds to block 715, where, as in the case of an R2 revision at block 713, post-R3 revision data is merged with pre-revision data, because they are comparable. From block 715, process flow now proceeds to another query block, to determine if the R3 revision has triggered different usage patterns than before the revision. If “Yes” then this R3 revision is treated as a significant revision, such as an R1 revision, and process flow moves to block 743, where the prior usage data is discarded, and an exemplary system builds, and then learns form, fresh statistics just as at block 711. From block 743 process flow moves to query block 745, to determine if the data maturity threshold has been reached.

From block 745, if the return is “Yes” then process flow moves to block 735, and autoscaler resource recommendations of both increase and decrease are implemented. If, however, the return at query block 745 is “No”, and the maturity threshold is not yet reached, then process flow moves to block 750, where only increase recommendations are implemented, and flow loops back to query block 745, until a “Yes” is returned, which allows flow to move to block 735.

Finally, it is noted that the process flow of FIG. 7 may be interrupted at any time if a new revision is identified at query block 705. Once that happens, the current revision, “revCurr” is replaced with a new one, and revCurr becomes the prior revision. Then process flow would proceed from query block 710 onwards, as just described.

FIG. 8, next described is a detailed example process flow for dynamically identifying revisions and how to responsively implement autoscaler recommendations, according to various embodiments. With reference thereto, process flow begins at block 801, where a new pod starts. Thus, the process of FIG. 8 applies to each pod running within a given container, and, in embodiments, the process runs continually for each pod within each container being supervised by an example system. In embodiments, an example system is triggered to perform the processing of FIG. 8 anytime a revision is detected.

From block 801, process flow moves to block 810, where pod parameters are acquired and evaluated. These parameters may include, for example, resource configuration, memory allocation, and the like, and they are accessed by an example autoscaler system according to various embodiments. Next, based on the received parameters, at query blocks 815 and 811, the algorithm determines what type of revision has occurred (this supplies the details as to how an example system detects whether a given revision is an R1, R2, or R3 revision; these details were not shown in FIG. 7). Depending upon the revision type identified, various process flow pathways are then taken, as next described.

Query block 815 determines whether the revision is an R1 revision, or not. It thus queries if this revision has a new resources configuration, which is set by a user. If, at query block 815 the response is “Yes”, then the revision is a R1 revision. Process flow then moves to block 840, where automation and recommendations are paused, because, as described above, the handling logic for an R1 revision is “discard prior data; build fresh stats until maturity threshold.”

From block 840, process flow moves to block 850, where the system waits for data above the minimum threshold to be acquired. From there, process flow moves to query block 855, where it is determined if the impact of the recommendation would be significant. If “Yes” at query block 855, and the impact of the recommendation is judged to be significant, then process flow moves to block 860, where the recommendations are implemented via the automation, and process flow then ends, until, of course a new pod is received, and the process starts anew. If, however, the response to query block 855 is “No”, then the new recommendation is not judged to be significant, and there is really no reason to implement it, so the next automation cycle is skipped, and no recommendation is implemented.

If, however, at query block 815, the response is a “No”, then the revision is either an R2 or an R3 revision. Process flow moves to a second query block, block 811, where it is determined whether a new code (but without a new resources configuration) has been implemented. If the return is “Yes” at query block 811, this means a user has updated code, but in a routine code deployment, as shown on the “Yes” pathway from block 811. This revision is thus an R2 revision that does not significantly change anything, and process flow moves to block 820, where new utilization patterns are looked for, and then to query block 825, to determine if utilization patterns have changed significantly.

If the response at query block 825 is a “Yes”, and utilization patterns have changed significantly, then process flow moves to block 850, to wait for sufficient usage data to be acquired in order to make a recommendation. In this pathway, the R2 revision has the effect of an R1 revision, so the system operates in increase only mode, as described above, until a sufficient data window has been acquired to make an actual recommendation responsive to this R2 revision. The remaining process flow from block 850 is as described above, with reference to the R1 revision pathway through blocks 855, 860 and 861.

If, however, the response to query block 825 is “No”, then process flow proceeds to block 830, where the system waits for new recommendations, and when the new recommendations are received, process flow moves to query block 755, described below in connection with the R1 process flow pathway.

Returning to the last revision type possibility, if the response at query block 811 is “No”, then the revision is an R3 revision, implemented by the autoscaler automation, and process flow moves to block 830, where the system waits for new recommendations, and, once the new recommendations have been received, process flow moves through query block 855 and its subsequent processing.

Various aspects of the invention described above are exemplary, and numerous variations are contemplated to be within the scope of the present disclosure.

Accordingly, systems and methods for dynamic revision awareness and responsive resource allocation recommendations have been described. For purposes of explanation, specific configurations and details have been set forth to provide a thorough understanding of aspects of the disclosed technology. However, it is understood by those skilled in the art that the disclosed technology can be practiced using some subset of the aspects as presented herein.

Different aspects are disclosed herein. Features of certain aspects can be combined with features of other aspects; thus, certain aspects can be combinations of features of multiple aspects.

While several embodiments or aspects of the disclosure have been described herein and/or shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed:

1. A method, comprising:
dynamically detecting a current revision to a software service running within a container;
identifying whether the current revision specifies a significant change to the software service or not;
in response to the identification:
selecting a time window in which to analyze the service's usage patterns (the “analyzed time window”); and
determining whether to include data regarding the service's usage patterns prior to the current revision in the analyzed time window or not; and
based on the usage patterns in the analyzed time window, recommending a right-sizing implementation for the service.

2. The method of claim 1, wherein the identification of the current revision as a significant change includes determining that the current revision includes a major specification update.

3. The method of claim 1, wherein in response to an identification of the current revision as a significant change, only including the service's usage patterns following the current revision in the analyzed time window.

4. The method of claim 3, further comprising setting the analyzed time window to begin at the current revision, and to last N days, where N is a positive real number.

5. The method of claim 4, wherein N is a positive real number between 3 and 45.

6. The method of claim 4, further comprising only implementing right-sizing recommendations that increase resources available to the service, until the N days have passed.

7. The method of claim 4, further comprising implementing right-sizing recommendations that both increase and decrease resources available to the service, once the N days have passed.

8. The method of claim 1, wherein in response to an identification of the current revision as not specifying a significant change to the software service, including at least some of the service's usage patterns prior to the current revision in the analyzed time window.

9. The method of claim 1, wherein the identification of the revision as not being a significant change includes identifying the current revision as either a routine code deployment, or an autoscaler adjustment.

10. The method of claim 1, wherein in response to an identification of the current revision as not including a significant change, setting the analyzed time window to include one or more days prior to the current revision.

11. The method of claim 10, further comprising setting the analyzed time window to last N days, wherein N is one of: a positive real number or a positive real number between 3 and 45.

12. The method of claim 10, further comprising setting the analyzed time window to begin at one or more prior revisions to the current revision, as long as each of the prior revisions is not significantly different from the current revision.

13. The method of claim 9, wherein, if the current revision is identified as an autoscaler adjustment, further comprising:
determining if the autoscaler revision shows significantly different usage patterns for the service relative to prior revisions, and
in response to a determination that it does:
only including the service's usage patterns following the current revision in the analyzed time window; and
only implementing right-sizing recommendations that increase resources available to the service until the duration of the analyzed time window has completed.

14. A computer-readable medium having computer-executable instructions stored thereon, wherein the instructions, when executed by one or more processors, cause the one or more processors to:
dynamically detect a current revision to a software service running within a container;
identify whether the current revision specifies a significant change to the software service or not;
in response to the identification:
select an analyzed time window; and
determine whether to include data regarding the service's usage patterns prior to the current revision in the analyzed time window or not; and
based on the usage patterns in the analyzed time window, recommend a right-sizing implementation for the service.

15. The computer-readable medium of claim 14, wherein to identify the current revision as a significant change includes to determine that the current revision includes a major specification update.

16. The computer-readable medium of claim 14, wherein the instructions, when executed by the one or more processors, further cause the one or more processors to:
in response to an identification of the current revision as a significant change, only include the service's usage patterns following the current revision in the analyzed time window.

17. The computer-readable medium of claim 16, wherein the instructions, when executed by the one or more processors, further cause the one or more processors to:
set the analyzed time window to begin at the current revision, and to last N days, wherein N is one of: a positive real number, or a positive real number between 3 and 45.

18. The computer-readable medium of claim 17, wherein the instructions, when executed by the one or more processors, further cause the one or more processors to:
only implement right-sizing recommendations that increase resources available to the service, until the N days have passed, and
implement right-sizing recommendations that both increase and decrease resources available to the service, once the N days have passed.

19. An apparatus comprising a processor and a memory storing instructions executable by the processor to:
dynamically detect a current revision to a software service running within a container;
identify whether the current revision specifies a significant change to the software service or not;
in response to the identification:
select an analyzed time window; and
determine whether to include data regarding the service's usage patterns prior to the current revision in the analyzed time window or not; and
based on the usage patterns in the analyzed time window, recommend a right-sizing implementation for the service.

20. The apparatus of claim 19, wherein the instructions stored in the memory are further executable by the processor to:
only implement right-sizing recommendations that increase resources available to the service, until data has been acquired for the entire analyzed time window, and
implement right-sizing recommendations that both increase and decrease resources available to the service, once data for the entire analyzed time window has been acquired.
